(19) United States
(12) Patent Application Publication
(10) Pub. No.: US 2013/0194503 A1
(43) Pub. Date: Aug. 1, 2013

(54) ELECTRONIC APPARATUS, EXTERNAL DEVICE, CONTROL METHOD OF AN ELECTRONIC APPARATUS, AND CONTROL PROGRAM OF AN ELECTRONIC APPARATUS

(71) Applicant: Joji Yamashita, Hachioji-shi (JP)

(72) Inventor: Joji Yamashita, Hachioji-shi (JP)

(21) Appl. No.: 13/671,181

(22) Filed: Nov. 7, 2012

(30) Foreign Application Priority Data
Jan. 31, 2012 (JP) 2012-019336

(51) Int. Cl. H04N 5/44; H04N 5/445

(52) U.S. Cl. CPC H04N 5/4403; H04N 5/44582
USPC 348/563; 348/734

(57) ABSTRACT

According to one embodiment, an electronic apparatus includes: connection units connected to respective external devices; a detecting section configured to receive a control command transmitted from at least one of the external devices, and detect whether or not the received control command has been transmitted from a control-permitted external device; a selecting section configured to select an external device from which to accept a control command according to settings made in advance if the detecting section has received plural control commands from plural ones of the external devices; and a control section configured to control the electronic apparatus according to the control command transmitted from the selected external device.

### CROSS REFERENCE TO RELATED APPLICATION(S)

The application is based upon and claims the benefit of priority from Japanese Patent Application No. 2012-019336 filed on Jan. 31, 2012, the entire contents of which are incorporated herein by reference.

### BACKGROUND

1. Field

The present invention relates to an electronic apparatus, an external device, a control method of an electronic apparatus, and a control program of an electronic apparatus.

2. Description of the Related Art

In recent years, electronic apparatus such as video display apparatus have come into wide use. And there are ones to which plural external devices are connected.

Techniques for controlling a video display apparatus (electronic apparatus) from plural external control devices (external devices) capable of controlling the video display apparatus in a state that the plural external control devices are connected to the video display apparatus have been proposed.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 shows how a video display apparatus (electronic apparatus) according to the embodiment is made controllable by plural external control devices (external devices).

FIG. 2 is a block diagram showing the configuration of the video display apparatus according to the embodiment.

FIG. 3 shows an external control device priority setting picture which is displayed on a display unit of the video display apparatus according to the embodiment.

FIG. 4 shows an external control device permission setting picture which is displayed on the display unit of the video display apparatus according to the embodiment.

FIG. 5 shows an external control device priority rank setting picture which is displayed on the display unit of the video display apparatus according to the embodiment.

FIG. 6 shows an occupying external control device notification picture which is displayed on the display unit of the video display apparatus according to the embodiment.

FIG. 7 shows information indicating an external control device that is exclusively controlling the video display apparatus according to the embodiment which is displayed on the display unit of the video display apparatus.

FIGS. 8A-8C show information indicating an external control device that is exclusively controlling the video display apparatus according to the embodiment which is displayed on the display units of other external control devices connected to the video display apparatus.

FIG. 9 shows another example external control device which is connected to the video display apparatus according to the embodiment.

FIG. 10 is a flowchart showing how the video display apparatus according to the embodiment operates.

### DETAILED DESCRIPTION

According to one embodiment, an electronic apparatus includes: connection units connected to respective external devices; a detecting section configured to receive a control command transmitted from at least one of the external devices, and detect whether or not the received control command has been transmitted from a control-permitted external device; a selecting section configured to select an external device from which to accept a control command according to settings made in advance if the detecting section has received plural control commands from plural ones of the external devices; and a control section configured to control the electronic apparatus according to the control command transmitted from the selected external device.

An embodiment will be hereinafter described with reference to the drawings.

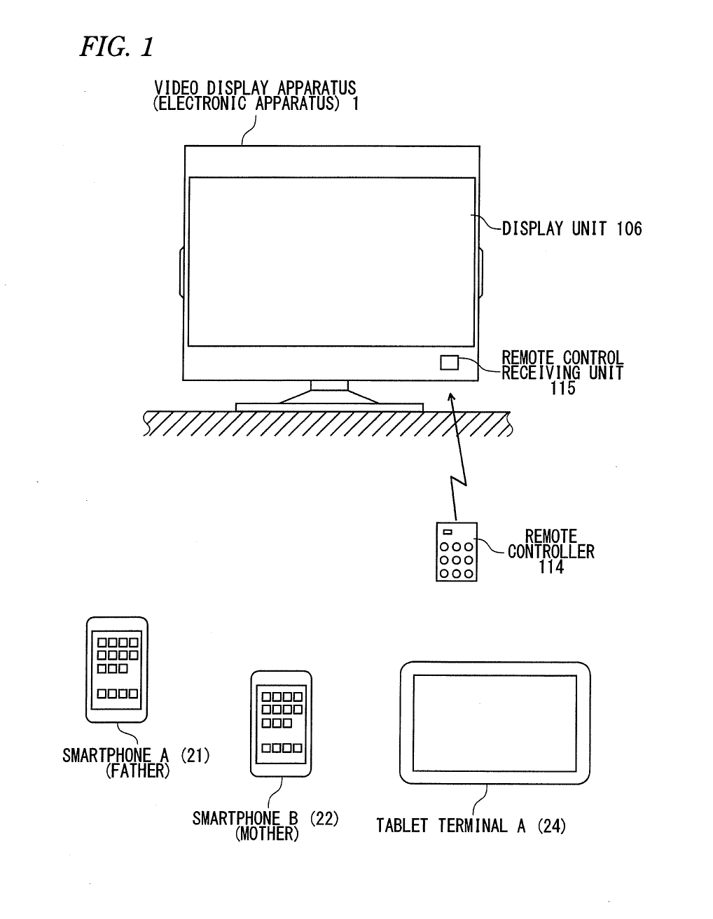

FIG. 1 shows how a video display apparatus (electronic apparatus) 1 according to the embodiment is made controllable by plural external control devices (external devices). As shown in FIG. 1, plural external control devices such as smartphones A (21) and B (22) and a tablet terminal A (24) are connected to the video display apparatus 1 so as to be able to control the video display apparatus 1. Each of the plural external control devices can thus control the video display apparatus 1.

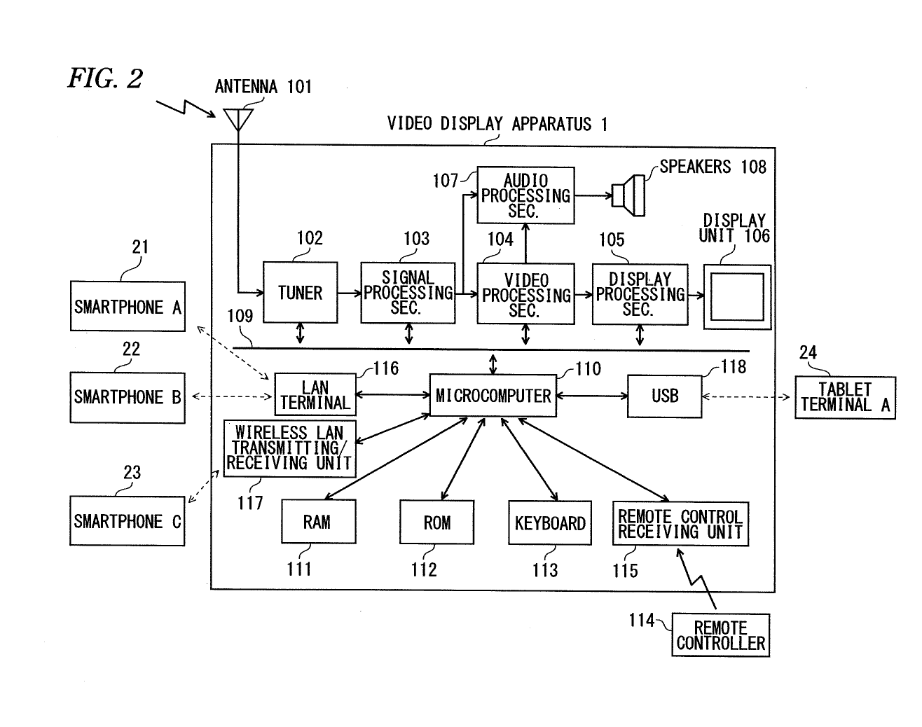

FIG. 2 is a block diagram showing the configuration of the video display apparatus 1 according to the embodiment. BS, CS, ground-wave, and like digital broadcasts which are broadcast from broadcasting stations (not shown) are received by an antenna 101 and supplied to a tuner 102. The tuner 102 tunes in to a viewing channel that is specified by a user by manipulating a remote controller 114, for example. The tuner 102 supplies a demodulated signal to a signal processing section 103.

The signal processing section 103 performs digital signal processing on the demodulated signal and outputs a resulting video signal and audio signal. The video signal that is output from the signal processing section 103 is received by a video processing section 104, where the video signal is adjusted so as to be suitable for a prescribed screen size. A display processing section 105 superimposes a graphic signal of text information, for example, and a resulting video signal is displayed on the screen of a display unit 106. The user views a broadcast program or the like thus displayed.

The audio signal that is output from the signal processing section 103 is received by an audio processing section 107, where the audio signal is subjected to audio processing. Audio signals that are output from the audio processing section 107 are received by speakers 108, which perform amplification etc. on the received audio signals and output a sound. The user can thus listen to the sound of the broadcast program or the like.

The tuner 102, the signal processing section 103, the video processing section 104, the display processing section 105, the audio processing section 107, etc. are connected to a microcomputer 110 by a communication line 109 such as an IIC bus, and thereby exchange data with each other under the control of the microcomputer 110. The IIC bus is an inter-IC bidirectional bus.

For example, a RAM 111, a ROM 112, a keyboard 113, and a remote control receiving unit 115 which receives a remote control signal from the remote controller 114 are connected to the microcomputer 110 and exchange signals and data with the microcomputer 110.

In the embodiment, the video display apparatus 1 has connection terminals for connection to external control devices, such as a LAN terminal 116 and a wireless LAN transmitting/receiving unit 117. The video display apparatus 1 can perform a network communication or the like with external control devices via these connection terminals.

The video display apparatus 1 can also exchange data with external control devices via a USB terminal 118 and a BT communication unit 119. USB (universal serial bus) is a serial bus standard for connection of a peripheral device to a computer. BT (Bluetooth (registered trademark)) is a short-range wireless communication standard.

In the embodiment, settings are made so that the video display apparatus 1 can be controlled by the plural external control devices (smartphones A (21) and B (22), tablet terminal A (24), etc.) via the connection terminals such as the LAN terminal 116 and the wireless LAN transmitting/receiving unit 117 as well as the USB terminal 118 and the BT communication unit 119.

Each of the plural external control devices (smartphones A (21) and B (22), tablet terminal A (24), etc.) can control the video display apparatus 1 by sending a control command to the video display apparatus 1.

However, for example, if control commands are sent simultaneously from plural ones of the external control devices (smartphones A (21) and B (22), tablet terminal A (24), etc.) to the video display apparatus 1, a conflict, contention, or the like may occur (e.g., a state that it is uncertain which control command the video display apparatus 1 should follow).

In the embodiment, the video display apparatus 1 receives a control command transmitted from one of the plural external control devices (smartphones A (21) and B (22), tablet terminal A (24), etc.) and detects whether or not the control command has been transmitted from an external control device that is in such a state as to be permitted to control the video display apparatus 1 itself.

If receiving plural control commands from plural ones of the external control devices (smartphones A (21) and B (22), tablet terminal A (24), etc.), the video display apparatus 1 detects, according to settings made in advance, one of those external control devices by which the video display apparatus 1 itself should be controlled actually. Then, the video display apparatus 1 controls itself according to the control command transmitted from the thus-detected external control device.

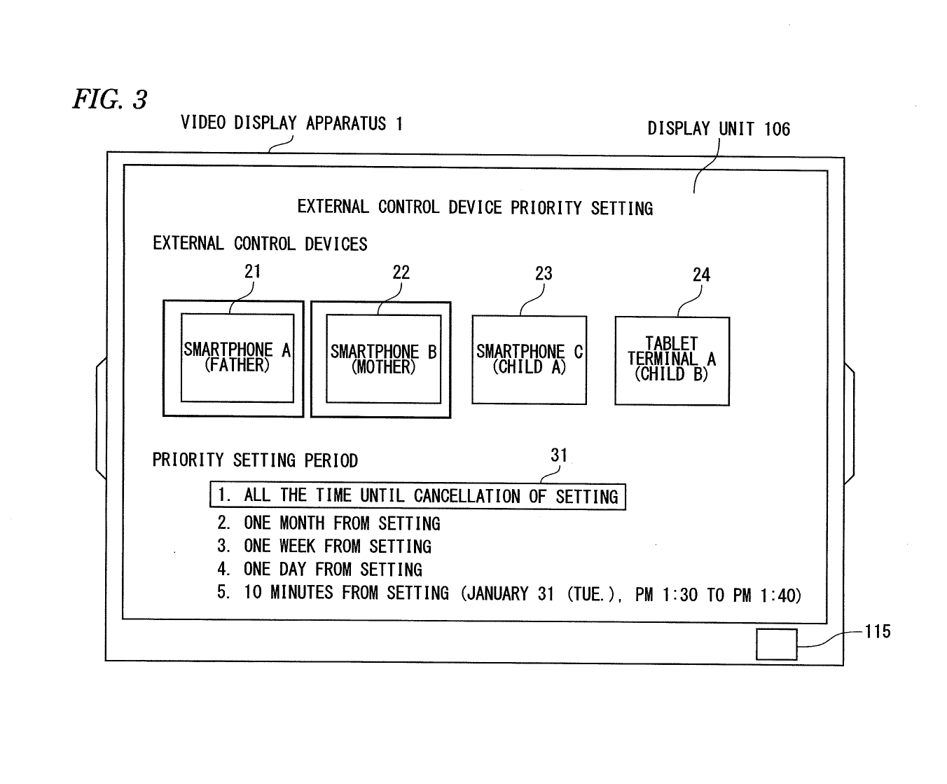

FIG. 3 shows an external control device priority setting picture which is displayed on the display unit 106 of the video display apparatus 1 according to the embodiment. As shown in FIG. 3, the plural external control devices capable of controlling the video display apparatus 1 are displayed on the display unit 106 of the video display apparatus 1. The displayed external control devices are the smartphone A (21) owned by a father, the smartphone B (22) owned by a mother, a smartphone C (23) owned by a child A, and the tablet terminal A (24) owned by a child B.

By manipulating the remote controller 114, for example, a user designates a desired external control device for which he or she wants to perform priority setting among the displayed external control devices and makes setting. A setting made is stored in, for example, a flash memory which is incorporated in the ROM 112.

The term “priority setting” means setting an external control device that should control the video display apparatus 1 with higher priority than the other ones among the displayed external control devices. Priority setting may be made of either a single external control device or plural external control devices. In this example, the user designates the smartphone A (21) owned by the father and the smartphone B (22) owned by the mother and makes priority setting for them.

It is also possible to set a priority setting period which is a period in which a priority setting is effective. In this example, “1. All the time until cancellation of setting,” “2. One month from setting,” “3. One week from setting,” “4. One day from setting,” and “5. 10 minutes from setting” are displayed as priority setting periods. A priority setting period may be set using specific dates and times such as “January 31 (Tue.), PM 1:30 to PM 1:40.” This setting is also stored in the flash memory which is incorporated in the ROM 112. In this example, “1. All the time until cancellation of setting” (denoted by reference numeral 31) is set.

With the above settings, the smartphone A (21) owned by the father and the smartphone B (22) owned by the mother can control the video display apparatus 1 with higher priority than smartphone C (23) owned by the child A and the tablet terminal A (24) owned by the child B all the time until cancellation of the above priority settings.

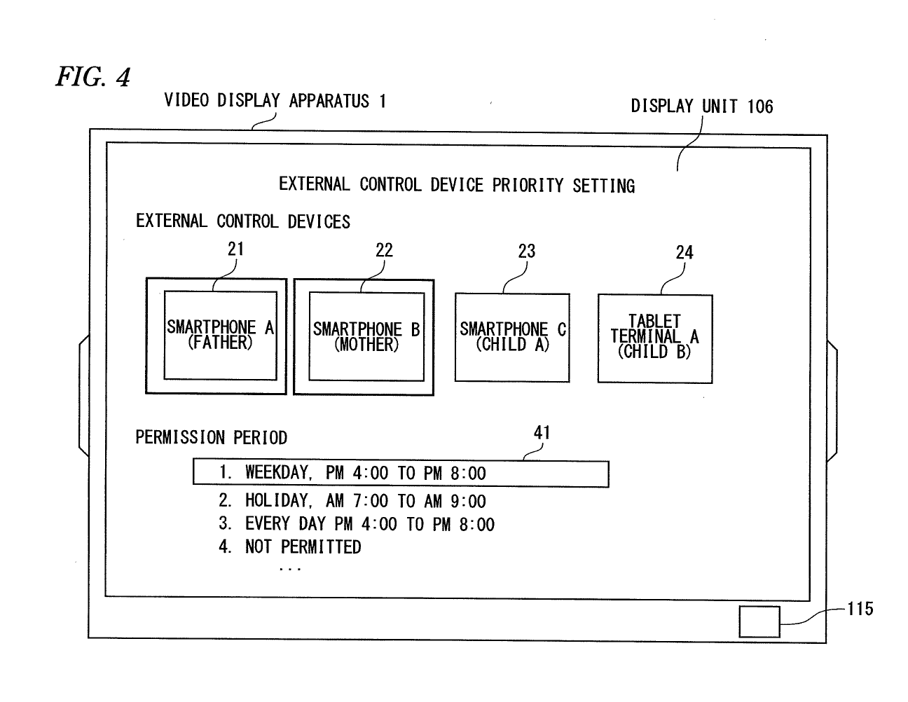

FIG. 4 shows a permission setting picture which is displayed on the display unit 106 of the video display apparatus 1 according to the embodiment. As shown in FIG. 4, the plural external control devices capable of controlling the video display apparatus 1 are displayed on the display unit 106 of the video display apparatus 1. The displayed external control devices are the smartphone A (21) owned by the father, the smartphone B (22) owned by the mother, the smartphone C (23) owned by the child A, and the tablet terminal A (24) owned by the child B.

By manipulating the remote controller 114, for example, a user designates a desired external control device for which he or she wants to perform permission setting among the displayed external control devices and makes setting. A setting made is stored in, for example, the flash memory which is incorporated in the ROM 112.

The term “permission setting” means setting an external control device that should control the video display apparatus 1 which should be permitted to manipulate the video display apparatus 1 under a prescribed condition among the displayed external control devices. Permission setting may be made of either a single external control device or plural external control devices. In this example, the user designates the smartphone C (23) owned by the child A and the tablet terminal A (24) owned by the child B and makes permission setting for them.

It is also possible to set a permission period which is a period in which a permission setting is effective. In this example, “1. Weekday, PM 4:00 to PM 8:00,” “2. Holiday, AM 7:00 to AM 9:00,” “3. Every day, PM 4:00 to PM 8:00,” “4. Not permitted,” etc. are displayed as permission periods. This setting is also stored in the flash memory which is incorporated in the ROM 112. In this example, “1. Weekday, PM 4:00 to PM 8:00” (denoted by reference numeral 41) is set.

For example, permission setting can be made of prescribed external control devices (in this example, the smartphone C (23) owned by the child A and the tablet terminal A (24) owned by the child B) to restrict viewing of broadcast programs by children.

With the above settings, the smartphone C (23) owned by the child A and the tablet terminal A (24) owned by the child B are permitted to control the video display apparatus 1 only from PM 4:00 to PM 8:00 on weekdays. In other words, the smartphone C (23) owned by the child A and the tablet terminal A (24) owned by the child B are not permitted to control the video display apparatus 1 in the periods other than PM 4:00 to PM 8:00 of weekdays.

In the embodiment, the priority setting described above with reference to FIG. 3 and the permission setting described above with reference to FIG. 4 may be combined together.

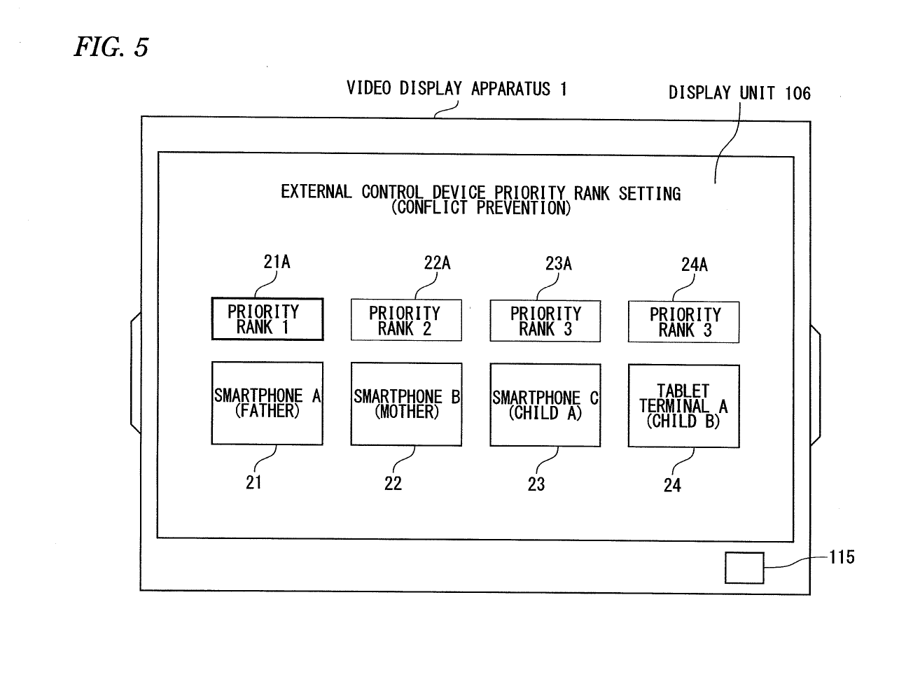

FIG. 5 shows an external control device priority rank setting picture which is displayed on the display unit 106 of the video display apparatus 1 according to the embodiment. As shown in FIG. 5, the plural external control devices capable of controlling the video display apparatus 1 are displayed on the display unit 106 of the video display apparatus 1. The displayed external control devices are the smartphone A (21) owned by the father, the smartphone B (22) owned by the mother, the smartphone C (23) owned by the child A, and the tablet terminal A (24) owned by the child B.

A user specifies desired priority ranks of the displayed external control devices by manipulating the remote controller 114, for example. Priority ranks of the displayed external control devices (the smartphone A (21) owned by the father, the smartphone B (22) owned by the mother, the smartphone C (23) owned by the child A, and the tablet terminal A (24) owned by the child B) are set and displayed so as to be associated with the respective displayed external control devices. Settings made are stored in, for example, a flash memory which is incorporated in the ROM 112.

The term “priority ranks” means priority ranks of the plural external control devices in controlling the video display apparatus 1, and are set in advance to prevent a conflict between (part of) the plural external control devices when they attempt to control the video display apparatus 1. A priority rank may be set for either a single external control device or plural external control devices. In this example, the smartphone A (21) owned by the father and the smartphone B (22) owned by the mother are given priority ranks “1” and “2,” respectively, and the smartphone C (23) owned by the child A and the tablet terminal A (24) owned by the child B are given a priority rank “3.”

With the above settings, if control commands are sent simultaneously from, for example, the smartphone A (21) owned by the father and the smartphone B (22) owned by the mother to control the video display apparatus 1, the control command sent from the smartphone A (21) owned by the father is employed with higher priority than that sent form the smartphone B (22) owned by the mother according to the above settings.

If control commands are sent simultaneously from the smartphone B (22) owned by the mother and the smartphone C (23) owned by the child A or the tablet terminal A (24) owned by the child B to control the video display apparatus 1, the control command sent from the smartphone B (22) owned by the mother is employed with higher priority than that sent form smartphone C (23) owned by the child A or the tablet terminal A (24) owned by the child B according to the above settings.

Although the above description is such that a user sets priority ranks, the embodiment is not limited to such a case. For example, a higher priority rank may be given to an external control device that has accessed the video display apparatus 1 earlier or a lager number of times. It is also possible to give a higher priority rank to an external control device that has accessed the video display apparatus 1 later.

In the embodiment, the priority setting, the permission setting, and the priority rank setting described above with reference to FIGS. 3-5, respectively, may be combined together.

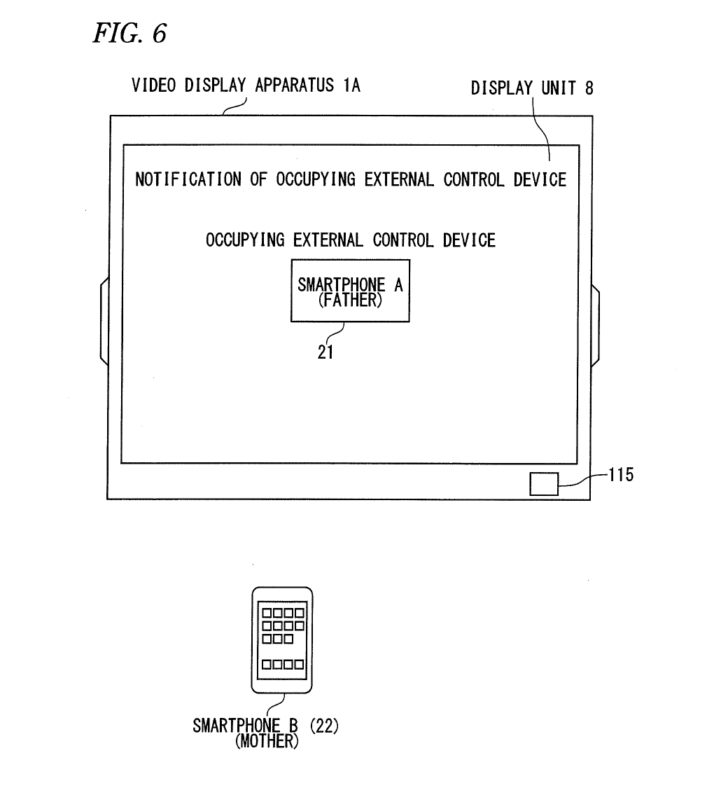

FIG. 6 shows an occupying external control device notification picture which is displayed on the display unit 106 of the video display apparatus 1 according to the embodiment.

In the embodiment, as described above, each of the plural external control devices (smartphones A (21), B (22), and C (23) and tablet terminal A (24)) can control the video display apparatus 1.

In this example, the smartphone A (21) owned by the father is set as an occupying external control device. The term “occupying external control device” means an external control device that is controlling the video display apparatus 1 exclusively among the plural external control devices.

If a control command is sent from, for example, the smartphone B (22) owned by the mother to the video display apparatus 1 in a state that the smartphone A (21) owned by the father is set as an occupying external control device, the video display apparatus 1 does not accept the control command that is sent from the smartphone B (22) owned by the mother.

In the embodiment, in this case, for example, information indicating the occupying external control device (see FIG. 6) is displayed which indicates that the control command that is sent from the smartphone B (22) owned by the mother is not accepted.

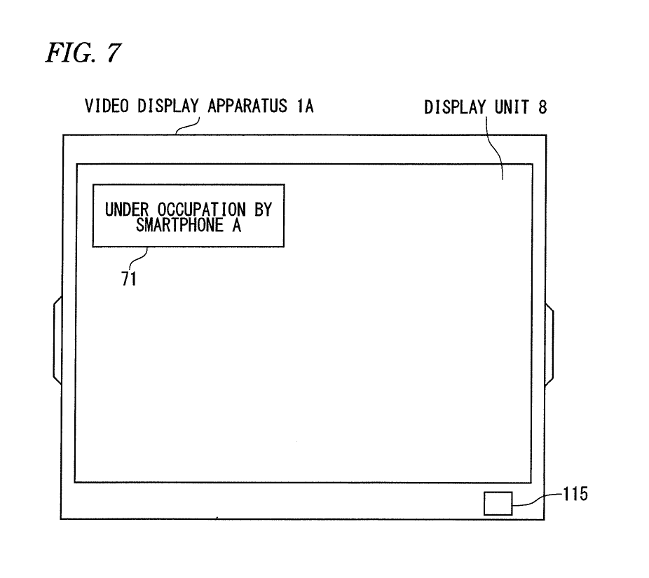

FIG. 7 shows information indicating an external control device that is exclusively controlling the video display apparatus 1 according to the embodiment which is displayed on the display unit 106 of the video display apparatus 1. “Under occupation by smartphone A” (denoted by reference numeral 71) is displayed on the display unit 106 of the video display apparatus 1 as information indicating an external control device that is controlling the video display apparatus 1 exclusively.

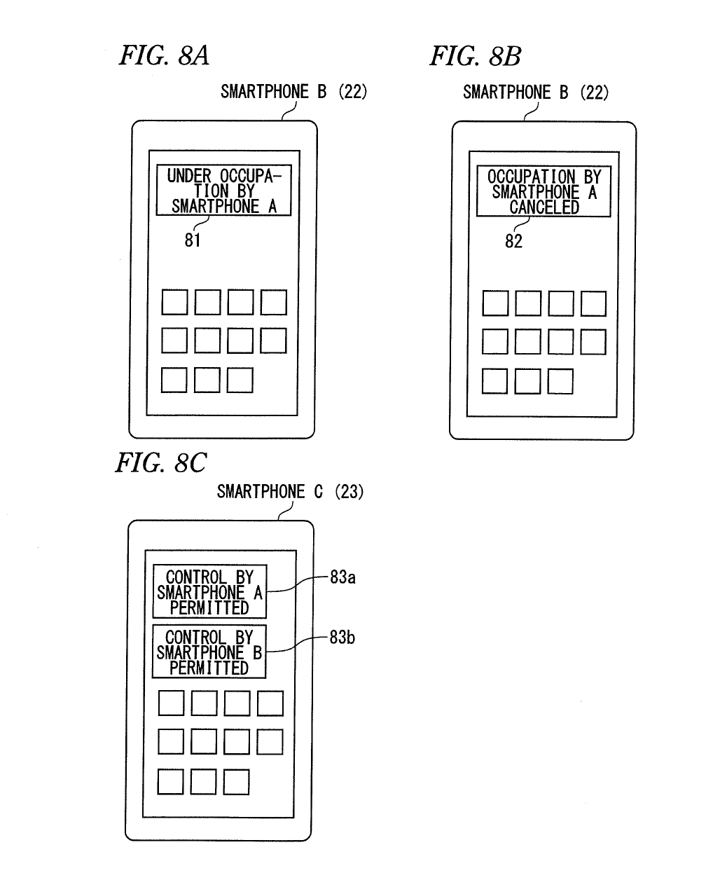

FIGS. 8A-8C show information indicating an external control device that is exclusively controlling the video display apparatus 1 according to the embodiment which is displayed on the display units of other external control devices connected to the video display apparatus 1.

In this example, as in the example of FIG. 7, the video display apparatus 1 is set so that the smartphone A (21) controls the video display apparatus 1 exclusively. This information is sent from the video display apparatus 1 to the plural external control devices (smartphones A (21), B (22), and C (23) and tablet terminal A (24)) which are connected to the video display apparatus 1.

As shown in FIG. 8A, the smartphone B (22) which is one of the plural external control devices receives this information and a message “Under occupation by smartphone A” (denoted by reference numeral 81) is displayed on the display unit of the smartphone B (22) when, for example, the smartphone B (22) is powered on by the user.

As shown in FIG. 8B, if the control occupation of the video display apparatus 1 by the smartphone A (21) is canceled, the smartphone B (22) receives this information and a message “Occupation by smartphone A canceled” (denoted by reference numeral 82) is displayed on the display unit of the smartphone B (22) when, for example, the smartphone B (22) is powered on by the user.

As shown in FIG. 8C, if the smartphone C (23) owned by the child A which is one of the plural external control devices receives the above information, messages “Control by smartphone A permitted” (denoted by reference symbol 83a) and “Control by smartphone B permitted” (denoted by reference symbol 83b) are displayed on the display unit of the smartphone C (23) when, for example, the smartphone C (23) is powered on by the user.

In the examples of FIGS. 8A and 8B which relate to control occupation of the video display apparatus 1, another external control device can be notified whether or not it can access the video display apparatus 1. In the example of FIG. 8C, another external control device can be notified whether or not it can access the video display apparatus 1 even in a case that the external control devices are given priority ranks (see FIG. 5).

More specifically, in a situation that the settings of FIG. 5 are made and the smartphones A (21), B (22), and C (23) owned by the father, mother, and child A, respectively, can access the video display apparatus 1, the messages “Control by smartphone A permitted” (denoted by reference symbol 83a) and “Control by smartphone B permitted” (denoted by reference symbol 83b) are displayed on the smartphone C (23) owned by the child A, whereby the child A can be notified of the fact that control by his or her own terminal having the priority rank “3” may be refused.

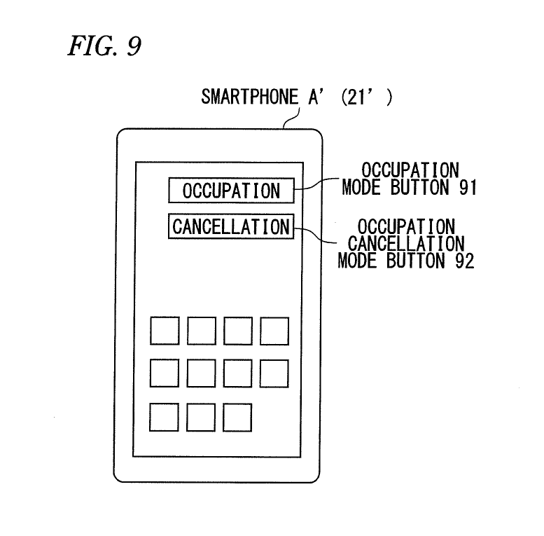

FIG. 9 shows another example external control device which is connected to the video display apparatus 1 according to the embodiment. As shown in FIG. 9, a smartphone A′ (21′) which is one of the external control devices connected to the video display apparatus 1 is provided with an occupation mode button 91 to be manipulated to control the video display apparatus 1 exclusively and an occupation cancellation mode button 92 to be manipulated to cancel control occupation of the video display apparatus 1. The smartphone A′ (21′) can control the video display apparatus 1 exclusively or cancel control occupation of the video display apparatus 1 when the user manipulates the occupation mode button 91 or the occupation cancellation mode button 92.

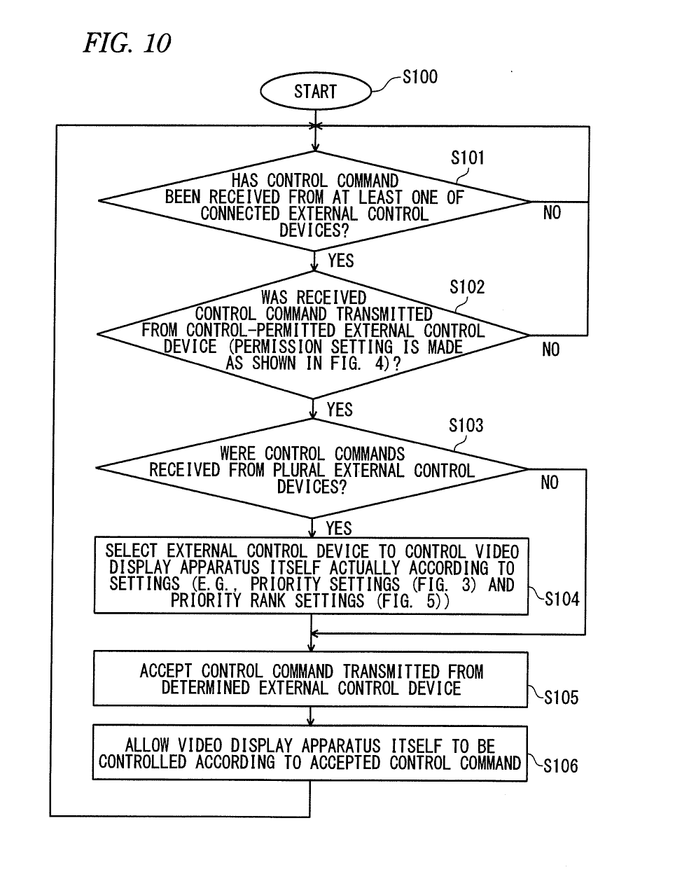

FIG. 10 is a flowchart showing how the video display apparatus 1 according to the embodiment operates. This process starts at step S100.

At step S101, the video display apparatus 1 detects whether or not it has received a control command from at least one of the external control devices (smartphones A (21), B (22), and C (23) and tablet terminal A (24)) connected to it. If the video display apparatus 1 detects that it has received a control command from at least one of the external control devices (S101: yes), the process moves to step S102. If the video display apparatus 1 detects that it has not received a control command from any of the external control devices (S101: no), the process returns to step S101.

At step S102, the video display apparatus 1 detects whether or not the control command was transmitted from a control-permitted external control device. Permission setting is made through the permission setting picture shown in FIG. 4, for example.

If the video display apparatus 1 detects that the control command was transmitted from a control-permitted external control device (S102: yes), the process moves to step S103. If the video display apparatus 1 detects that the control command was not transmitted from a control-permitted external control device (S102: no), the process returns to step S101.

At step S103, the video display apparatus 1 detects whether or not it received control commands from plural external control devices (smartphones A (21), B (22), and C (23) and tablet terminal A (24)).

If the video display apparatus 1 detects that it received control commands from plural external control devices (S103: yes), the process moves to step S104. If the video display apparatus 1 detects that it did not receive commands from plural external control devices (S103: no), the process moves to step S105.

At step S104, the video display apparatus 1 selects an external control device to control the video display apparatus 1 itself actually according to settings made in advance. For example, the settings made in advance are priority settings (see FIG. 3) and priority rank settings (see FIG. 5).

At step S105, the video display apparatus 1 accepts the control command transmitted from the determined external control device.

At step S106, the video display apparatus 1 allows itself to be controlled according to the accepted control command. Then, the process returns to step S101.

The video display apparatus (electronic apparatus) according to the embodiment is equipped with the external control device connection terminals and units (LAN terminal 116, wireless LAN transmitting/receiving unit 117, USB terminal 118, and BT communication unit 119) to which the external control devices (external devices; smartphones A (21), B (22), and C (23) and tablet terminal A (24)) are connected so as to be able to control the video display apparatus 1.

The video display apparatus is equipped with a first detecting section (microcomputer 110) for receiving a control command from at least one of the external control devices and detecting whether or not the received control command has been transmitted from an external control device that is permitted to control the video display apparatus itself.

The video display apparatus is equipped with a second detecting section (microcomputer 110) for selecting an external control device to control the video display apparatus itself actually according to settings made in advance if plural control commands have been received from plural ones of the external control devices.

The video display apparatus is equipped with a control section (microcomputer 110) for controlling the video display apparatus itself according to the control command transmitted from the selected external control device.

The video display apparatus is equipped with a permission setting picture output section for outputting a setting picture (see FIG. 4) that enables setting of an external control device that is permitted to control the video display apparatus itself.

The video display apparatus is equipped with a priority setting picture output section for outputting a setting picture (see FIG. 3) that enables setting of an external control device that can control the video display apparatus itself with higher priority than the other external control devices.

The video display apparatus is equipped with a priority rank setting picture output section for outputting a setting picture (see FIG. 5) that enables setting of control priority ranks of external control devices that are permitted to control the video display apparatus itself.

The video display apparatus outputs information indicating the external control device to control the video display apparatus itself actually if a control command has been received from an external control device that is not the external control device to control the video display apparatus itself actually.

The video display apparatus outputs information indicating that the detected external control device is to control the video display apparatus itself actually.

The video display apparatus outputs, to the external control devices other than the external control device to control the video display apparatus itself actually, information indicating that the detected external control device is to control the video display apparatus itself actually.

Each external control device according to the embodiment is equipped with a receiving section for receiving the information indicating that the detected external control device is to control the video display apparatus itself actually, the information being output from the video display apparatus, and a display unit for displaying the received information.

Each external device according to the embodiment can instruct the video display apparatus to render each of the settings made in advance effective or not effective.

According to the above-described embodiment, in a state that the video display apparatus can be controlled by plural external control devices, it can be prevented from accepting plural control commands simultaneously.

The user of an external control device can temporarily prohibit external control devices other than his or her own one from controlling the video display apparatus.

As is understood from the above description, in a video display apparatus (electronic apparatus) which can be controlled by plural external control devices (external devices), the invention makes it possible to determine an external control device(s) that can control the video display apparatus, when necessary.

All the steps of the control process according to the embodiment can be implemented by software. Therefore, the advantages of the embodiment can be obtained merely by running a program for the control process by installing it in an ordinary computer through a computer-readable storage medium that is stored with the program.

The invention is not limited to the above embodiment itself and, in the practice stage, may be embodied in such a manner that constituent elements are modified in various manners without departing from the spirit and scope of the invention. And various inventive concepts may be conceived by properly combining plural constituent elements disclosed in the embodiment. For example, several ones of the constituent elements of the embodiment may be omitted.

What is claimed is:

1. An electronic apparatus comprising:
connection units connected to respective external devices;
a detecting section configured to receive a control command transmitted from at least one of the external devices, and detect whether or not the received control command has been transmitted from a control-permitted external device;
a selecting section configured to select an external device from which to accept a control command according to settings made in advance if the detecting section has received plural control commands from plural ones of the external devices; and
a control section configured to control the electronic apparatus according to the control command transmitted from the selected external device.

2. The electronic apparatus according to claim 1, further comprising
a permission setting picture output section configured to output a setting picture that enables setting of a control-permitted external device.

3. The electronic apparatus according to claim 1, further comprising
a priority setting picture output section configured to output a setting picture that enables setting of a control-permitted external device that is given higher priority than the other external devices.

4. The electronic apparatus according to claim 1, further comprising
a priority rank setting picture output section configured to output a setting picture that enables setting of control priority ranks of control-permitted external devices.

5. The electronic apparatus according to claim 1, further comprising
an output section configured to output information indicating a control-permitted external device or devices if the detecting section has received a control command from an external device that is not a control-permitted external device.

6. The electronic apparatus according to claim 1, further comprising
an output section configured to output information indicating that the control command is accepted from the detected external device.

7. The electronic apparatus according to claim 1, further comprising
an output section configured to output information indicating that the control command is accepted from the detected external device to the external devices other than a control-permitted external device or devices.

8. An external device comprising:
a receiving section configured to receive information indicating that a control command is accepted from a detected external device, the information being output from an electronic apparatus; and
a display unit for displaying the received information, wherein
an electronic apparatus comprising:
connection units connected to respective external devices;
a detecting section configured to receive the control command transmitted from at least one of the external devices, and detect whether or not the received control command has been transmitted from a control-permitted external device;
a selecting section configured to select an external device from which to accept a control command according to settings made in advance if the detecting section has received plural control commands from plural ones of the external devices;
a control section configured to control the electronic apparatus according to the control command transmitted from the selected external device; and
an output section configured to output information indicating that the control command is accepted from the detected external device to the external devices other than a control-permitted external device or devices

9. An external device comprising
an instructing section configured to instruct an electronic apparatus to render each of settings made in advance effective or not effective, wherein
an electronic apparatus comprising:
connection units connected to respective external devices;
a detecting section configured to receive the control command transmitted from at least one of the external devices, and detect whether or not the received control command has been transmitted from a control-permitted external device;
a selecting section configured to select an external device from which to accept a control command according to settings made in advance if the detecting section has received plural control commands from plural ones of the external devices; and
a control section configured to control the electronic apparatus according to the control command transmitted from the selected external device.

10. A control method of an electronic apparatus, comprising:
connecting the electronic apparatus to external devices;
receiving a control command transmitted from at least one of the external devices, and detecting whether or not the received control command has been transmitted from a control-permitted external device;
selecting an external device from which to accept a control command according to settings made in advance if the detecting step has received plural control commands from plural ones of the external devices; and
controlling the electronic apparatus according to the control command transmitted from the selected external device.

11. A control program of an electronic apparatus for causing the electronic apparatus to execute the steps of:
connecting the electronic apparatus to external devices;
receiving a control command transmitted from at least one of the external devices, and detecting whether or not the received control command has been transmitted from a control-permitted external device;
selecting an external device from which to accept a control command according to settings made in advance if the detecting step has received plural control commands from plural ones of the external devices; and
controlling the electronic apparatus according to the control command transmitted from the selected external device.
